(19) United States
(12) Patent Application Publication
(10) Pub. No.: US 2006/0279550 A1
(43) Pub. Date: Dec. 14, 2006

(54) Integrally formed touchpad module

(76) Inventors: Jia-Yih Lii, Taichung City (TW); Yung-Lieh Chien, Taoyuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/274,174

(22) Filed: Nov. 16, 2005

(30) Foreign Application Priority Data
Jun. 13, 2005 (TW) 094209869

(51) Int. Cl. G09G 5/00

(52) U.S. Cl. 345/173

(57) ABSTRACT

An integrally formed touchpad module comprises a touchpad integrated with peripheral functional buttons and directly attached underneath the equipment case. Therefore, no holes need to be opened on the case and no additional real buttons are required in the touchpad module mechanism. It is thus achieved the goals of integrally formed mechanism, cost reduction, waterproof, anti-dust and good-looking.

### FIELD OF THE INVENTION

The present invention is generally related to a touchpad module and, more particularly, to a touchpad module that integrates peripheral functional buttons with a touchpad.

### BACKGROUND OF THE INVENTION

Touchpad module has been widely applied in various electronic products, such as notebook computers, keyboards and other pointing devices for simulating computer mouse. However, the touchpad nowadays only provides limited functions such as cursor movement and mouse left button. Moreover, for the reason that users are used to the pressing feeling of real buttons, additional real buttons are required as functional buttons in order to practice the left and right button functions of a mouse and other functions. FIGS. 1 to 5 shows various current touchpad modules. Referring to FIG. 1, touchpad module 100 comprises touchpad 110 for providing cursor movement function for users, and functional buttons 120 and 130 located underneath the touchpad 1 10 to perform mouse left button and right button functions, respectively. Referring to FIG. 2, touchpad module 100 comprises touchpad 110 for providing cursor movement function for users, functional buttons 120 and 130 located underneath the touchpad 110 to perform mouse left button and right button functions, respectively, and several hot keys 140 to 180 located underneath the functional keys 120 and 130 to control the actions of electronic product when it is performing specific functions, for example rewind, fast forward, play, pause and stop, etc. during playing a video tape or disk. Referring to FIG. 3, touchpad module 100 comprises touchpad 110 for providing cursor movement function for users, and functional buttons 120, 130 and 190 located underneath the touchpad 110 to perform mouse left button, mouse right button and specific functions. Referring to FIG. 4, touchpad module 100 comprises touchpad 110 for providing cursor movement function for users, and functional buttons 120, 130 and 200 located underneath the touchpad 110 to perform mouse left button, right button and middle button functions, respectively. Referring to FIG. 5, touchpad module 100 comprises touchpad 110 for providing cursor movement function for users, functional buttons 120 and 130 for performing mouse left button and right button functions, respectively, and direction button 210 for controlling a menu or the movement of a window along different directions. Each touchpad modules 100 shown in FIGS. 1-5 comprises at least two separated components such as the touchpad 110 and real buttons 120-210 and therefore, the cases of the electronic products need to be opened with holes around the peripheral of the touchpad 110 for the real buttons 120-210, which will lead to the waterproof difficulty on the whole mechanism due to the gap 220 between the real buttons 120-210 and open holes. Further, open holes and additional real buttons on the mechanism make electronic products have unavoided high cost.

Therefore, it is desired an integrally formed touchpad module that integrates peripheral functional buttons with touchpad to achieve the goal of waterproof, anti-dust, good looking and reduced cost.

### SUMMARY OF THE INVENTION

An object of the present invention is to provide an integrally formed touchpad module that integrates peripheral functional buttons with touchpad.

According to the present invention, an integrally formed touchpad module comprises a touchpad integrated with peripheral functional buttons and directly attached underneath the equipment case. Therefore, no holes need to be opened on the case and no additional real buttons are required in the touchpad module mechanism. It is thus achieved the goals of integrally formed mechanism, cost reduction, waterproof, anti-dust and good-looking.

### BRIEF DESCRIPTION OF DRAWINGS

These and other objects, features and advantages of the present invention will become apparent to those skilled in the art upon consideration of the following description of the preferred embodiments of the present invention taken in conjunction with the accompanying drawings, in which:

FIGS. 1 to 5 show various conventional touchpad modules;

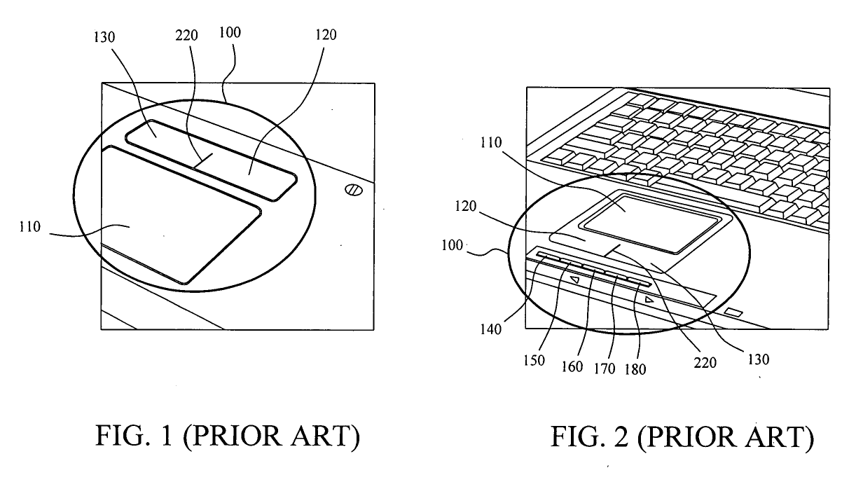

FIG. 6 shows a first embodiment according to the present invention;

FIG. 7 shows a second embodiment according to the present invention;

FIG. 8 shows a third embodiment according to the present invention; and

FIG. 9 shows a fourth embodiment according to the present invention.

### DETAILED DESCRIPTION OF THE INVENTION

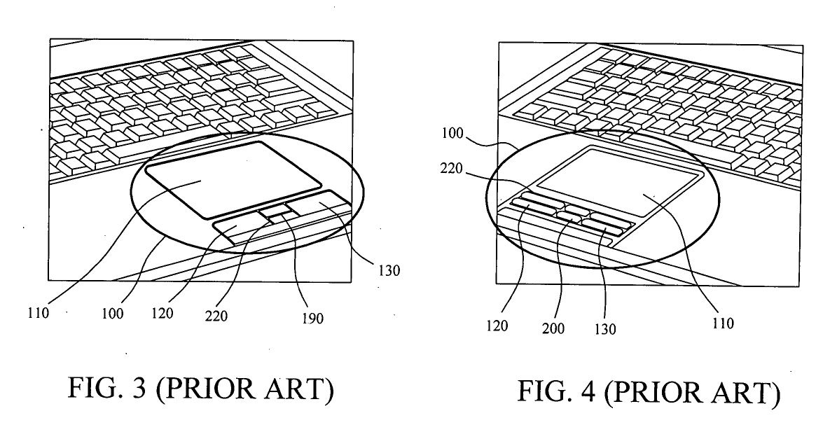

FIG. 6 shows an integrally formed touchpad module according to the present invention, which comprises a touchpad 610 with a cursor operation region 620 and two button regions 630 and 640 defined thereon, by which users may control the movement of a cursor on a window by operating on the cursor operation region 620, and practice the pressing of mouse left and right buttons by touching the button regions 630 and 640, respectively. In another embodiment, the cursor operation region 620 and button regions 630 and 640 may be provided by more than one touchpad.

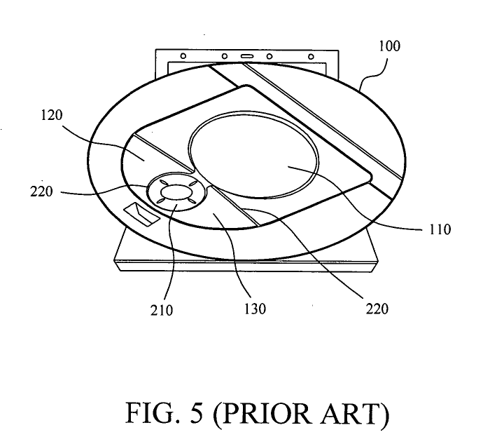

FIG. 7 shows an integrally formed touchpad module according to the present invention, which comprises a touchpad 610 with a cursor operation region 620 and three button regions 630, 640 and 650 defined thereon, by which users may control the movement of a cursor on a window by operating on the cursor operation region 620, and practice the pressing of mouse left, right and middle buttons by touching the button regions 630, 640 and 650, respectively. In another embodiment, the cursor operation region 620 and button regions 630, 640 and 650 may be provided by more than one touchpad.

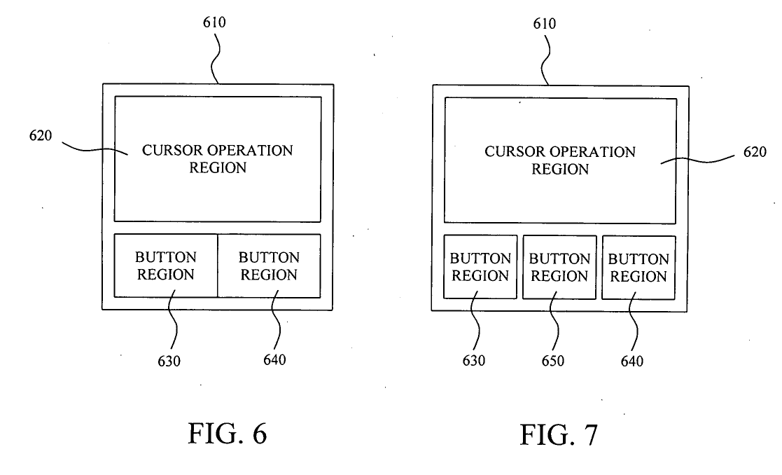

FIG. 8 shows an integrally formed touchpad module according to the present invention, comprising a touchpad 610 on which there defined a cursor operation region 620 and three button regions 630, 640 and 660. The cursor operation region 620 provides for users to control the movement of a cursor on a window, and the button regions 630 and 640 provide the left and right button functions of a mouse, respectively. The button region 660 serves as a direction button, which provides for the control of four directions, i.e. up, down, left and right. For example, touching the upper part of the button region 660 will move a menu or window upward, and similarly, touching the lower, left and right parts of the button region 660 will move a menu or window downward, leftward and rightward, respectively. The patterns on the button region 660 are printed on the touchpad 610, or provided by tags attached on the touchpad 610, or directly formed on the surface of the touchpad 610. In another embodiment, all the regions 620,630, 640 and 660 may be provided by more than one touchpad.

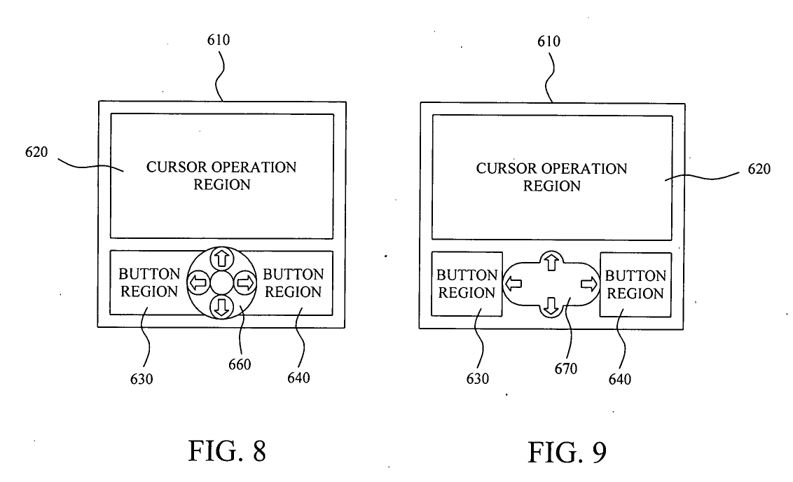

FIG. 9 shows an integrally formed touchpad module according to the present invention, comprising a touchpad 610 on which there defined a cursor operation region 620, two button regions 630 and 640, and a scroll control region 670. The cursor operation region 620 provides for users to control the movement of a cursor on a window, the button regions 630 and 640 provide the left and right button functions of a mouse, respectively, and the scroll control region 670 provides for users to scroll a menu or window by sliding their fingers thereon. Again, in another embodiment, all the regions 620, 630, 640 and 670 may be provided by more than one touchpad.

According to the present invention, touchpad is defined to provide button or key functions that are conventionally provided by real buttons or keys nearby or around the touchpad, and therefore those buttons or keys are integrated with the touchpad to be in one body, such that an integrally formed touchpad module is obtained and may be directly attached underneath the case of the electronic products. As a result, no additional real button or key components are necessary, and holes for these conventional real buttons or keys are not required to be opened in the mechanism. It is thus achieved the goals of waterproof, anti-dust, cost reduction and good looking.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. An integrally formed touchpad module comprising:
at least a touchpad having a plurality of defined regions thereon for providing a plurality of functional buttons around the at least a touchpad.

2. The touchpad module of claim 1, wherein the plurality of defined regions comprise a cursor operation region, button region and scroll control region.

3. The touchpad module of claim 1, wherein the plurality of functional buttons comprise a left button, right button and middle button of a mouse.

4. The touchpad module of claim 1, wherein the plurality of functional buttons comprise a wheel of a mouse.

5. The touchpad module of claim 1, wherein the plurality of functional buttons comprise a direction button.
